(19) United States
(12) Patent Application Publication
(10) Pub. No.: US 2024/0059111 A1
(43) Pub. Date: Feb. 22, 2024

(54) QUICK CONNECT BALL COUPLER

(71) Applicant: Gen-Y Creations, LLC, Nappanee, IN (US)

(72) Inventor: Carl J. Borkholder, Nappanee, IN (US)

(73) Assignee: Gen-Y Creations, LLC, Nappanee, IN (US)

(21) Appl. No.: 17/888,663

(22) Filed: Aug. 16, 2022

(51) Int. Cl. B60D 1/06; B60D 1/62

(52) U.S. Cl. CPC B60D 1/065; B60D 1/62

(57) ABSTRACT

A coupler for a trailer is provided for capturing a hitch ball that is affixed to a towing vehicle. The coupler includes a hemisphere cylinder pocket to receive the hitch ball and a lever to capture the hitch ball. When the hitch ball enters the pocket, it moves the lever from a release position to a captured position. In either position, a portion of the lever protrudes into the pocket. A locking pin is biased against the lever. Once moved to the captured position, an aperture on the lever aligns with the locking pin and the locking pin extends through the locking pin, locking the lever in the captured position. To release the coupler, the user pulls the locking pin clear of the lever. The locking pin can be pulled clear with a manual release handle or an electrical actuator.

### BACKGROUND OF THE INVENTION

The present disclosure relates to couplers between a towing vehicle and a trailer. The most common coupler involves a ball and socket, which provides a secure connection that still allows freedom of movement between the vehicle and trailer. Ball and socket couplers have been around for many years and have proven to be a reliable and flexible connection, but can be difficult to align, mate, and secure. Others have attempted to design a simple coupler, but these can still require significant hand strength to operate, have dangerous pinch points, or be difficult to release. In addition, preventing vandalism or theft usually involves the user having to add a separate lock, where keys are misplaced or the combination is forgotten. For these reasons, an improved ball coupler is needed.

### SUMMARY OF THE INVENTION

The present disclosure describes a quick connect ball coupler that is released either through a lever or an actuator. The coupler has a hemisphere cylinder cavity that receives a hitch ball and a lever that can pivot between a captured and a release position.

The coupler has a fixed ball pocket with a cylindrical inside surface extending to a hemispherical inside surface to form an inside envelope. The fixed ball pocket has a notch that interrupts a portion of the hemispherical and cylindrical surfaces. A lever is located in the notch and can pivot between a captured position and a release position. A portion of the lever extends into said inside envelope and the lever has a locking aperture. When the lever is in the release position, the portion of the lever that extends into the inside envelope is adjacent the hemispherical surface and when the lever is in the captured position, the portion of the lever that extends into the inside envelope is adjacent the cylindrical surface. A locking pin is slidable along a locking axis between a locked and unlocked position. The locked position is defined as the locking pin extending through the locking aperture in the lever and the unlocked position is defined as the locking pin being clear of said lever. The locking pin is biased towards the locked position and is slidable through the locking aperture to the locked position when the lever is in said captured position. The locking pin is moved to the unlocked position by a release handle or electric actuator.

### BRIEF DESCRIPTION OF THE DRAWINGS

FIG. 1 is a top isometric view of a coupler in use connecting a trailer and towing vehicle;

FIG. 2 is a top isometric view of the coupler in FIG. 1;

FIG. 3 is a bottom isometric view of the coupler in FIG. 2;

FIG. 4 is an exploded isometric view of the coupler in FIG. 2;

FIG. 5 is an exploded isometric view of the housing alignment to the gooseneck tube and ball pocket;

FIG. 6 is a side section view 6-6 of the coupler in FIG. 2 in the captured position;

FIG. 7 is a side section view 6-6 of the coupler in FIG. 2 in the released position;

FIG. 8 is a top section view 8-8 of the coupler in FIG. 2 in the captured position;

FIG. 9 is a top isometric view showing a bumper-mounted embodiment of the hitch coupler in use connecting a trailer and towing vehicle;

FIG. 10 is a top isometric view of the coupler in FIG. 9;

FIG. 11 is a top isometric view of a manually-operated embodiment of the coupler shown in FIG. 1;

FIG. 12 is a bottom isometric view of the coupler shown in FIG. 11;

FIG. 13 is a side section view 13-13 of the coupler in FIG. 11 in the captured position;

FIG. 14 is an exploded isometric view of the coupler in FIG. 11;

FIG. 15 is a top section view 15-15 of the coupler in FIG. 11; and

FIG. 16 is a top section view 15-15 of the coupler in FIG. 11 after being moved to the unlocked position.

### DESCRIPTION OF THE PREFERRED EMBODIMENT

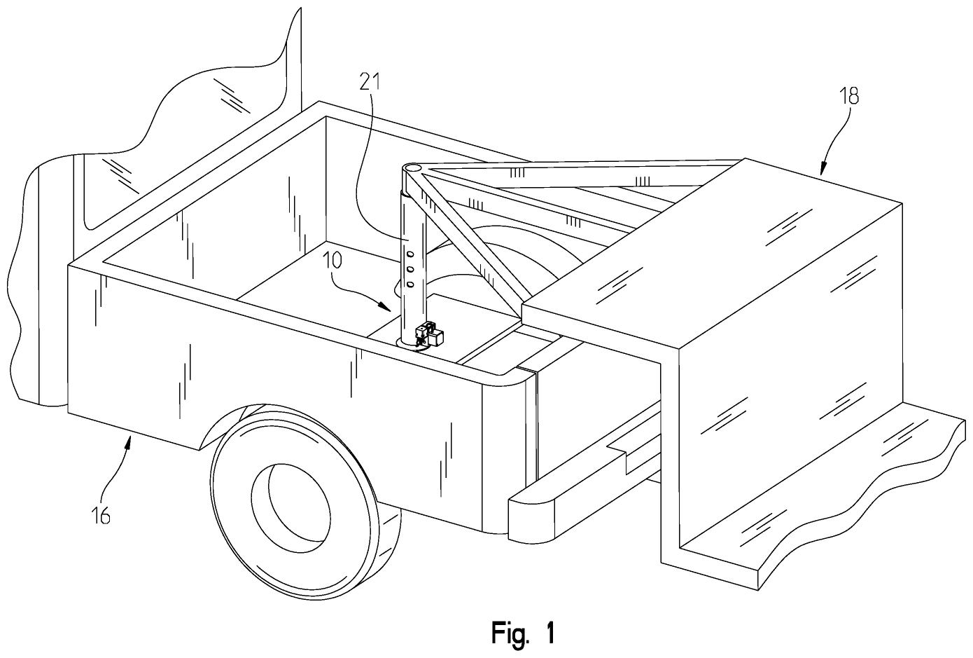

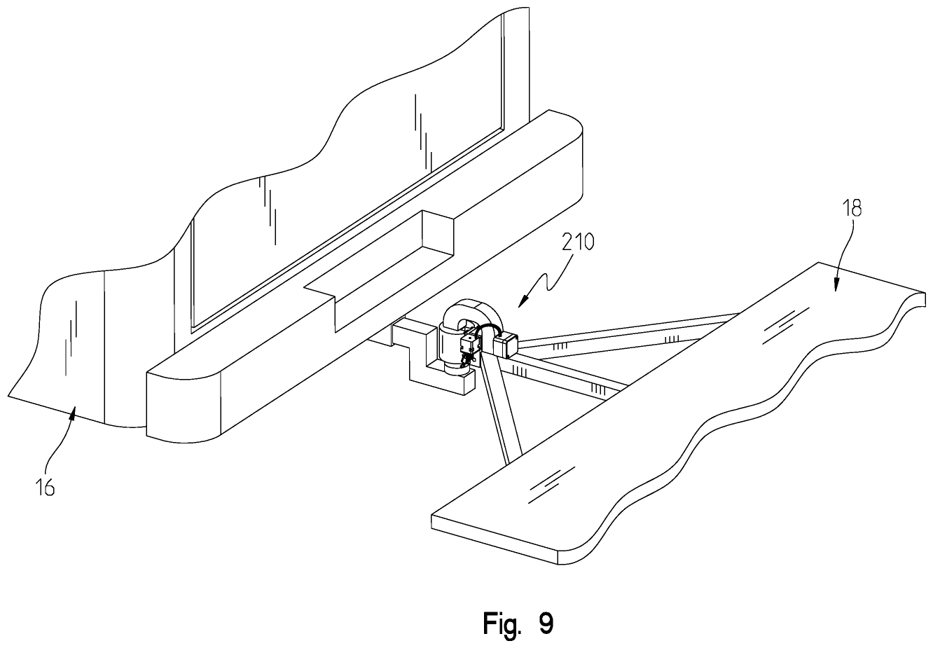

A coupler 10 is designed to mate to a standard hitch ball 12 having a partially spherical surface 14. The hitch ball 12 is typically affixed to a towing vehicle 16, either at the rear of the vehicle as shown in FIG. 9 or above an axle as shown in FIG. 1. When the hitch ball 12 is affixed to the vehicle frame above an axle, it is typically when the vehicle is set up for towing a gooseneck trailer.

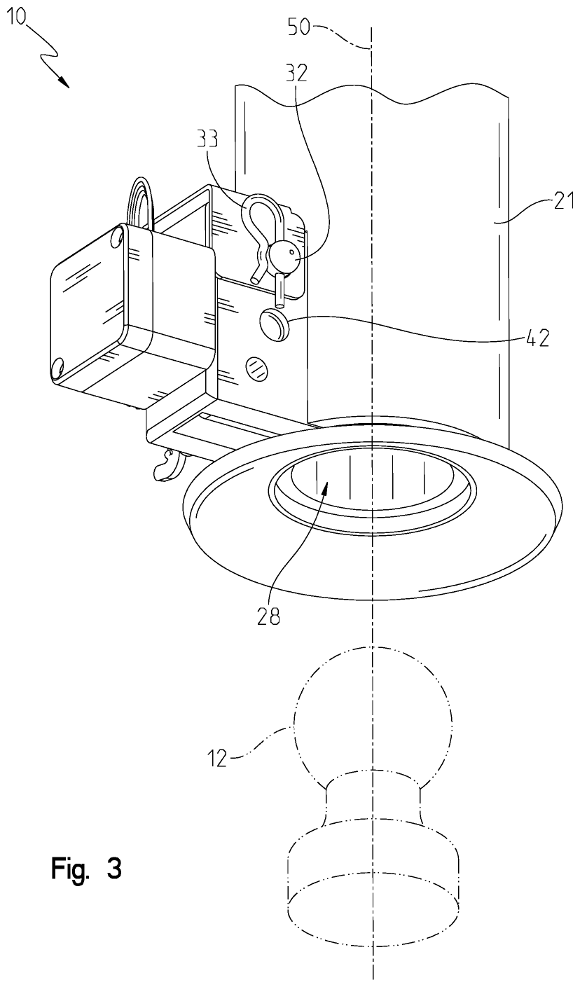

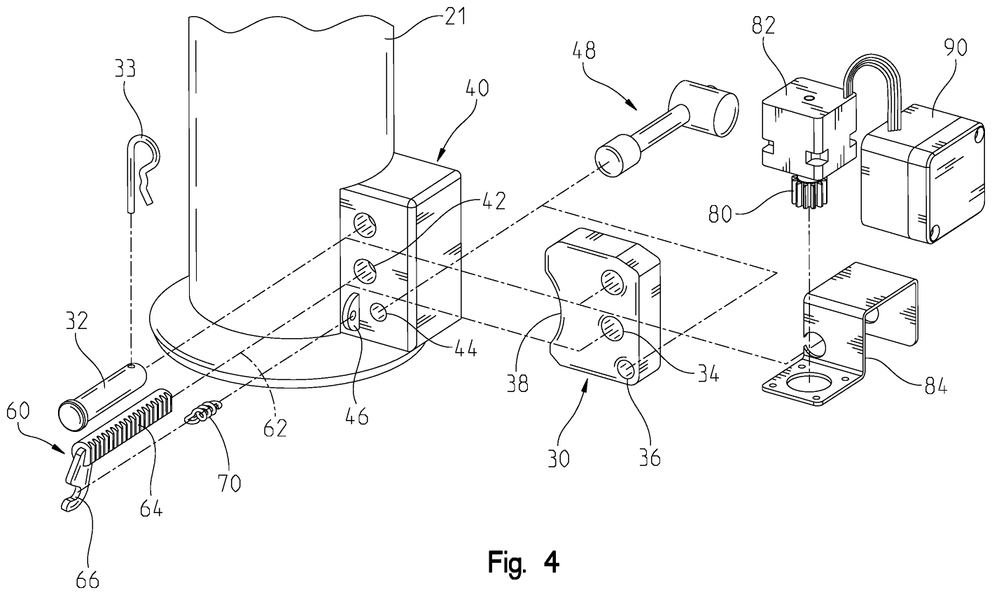

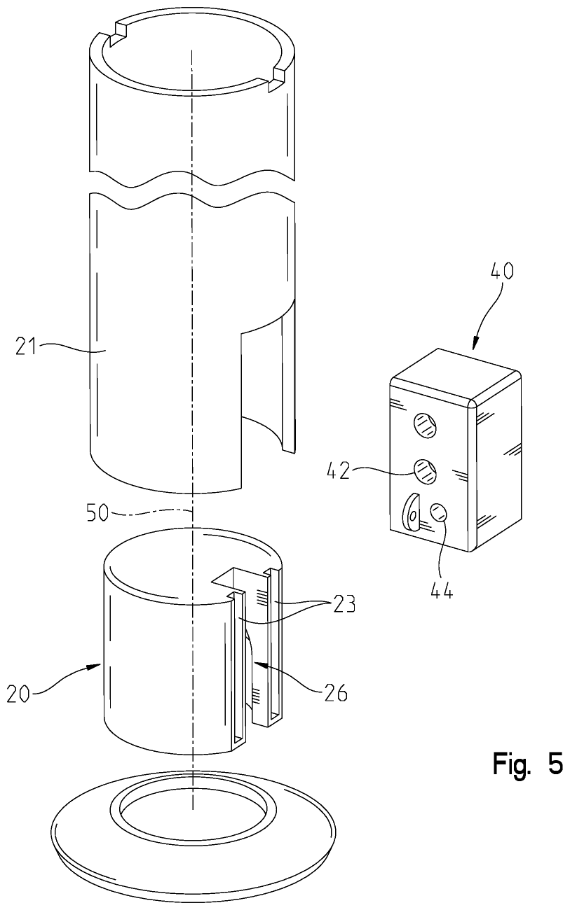

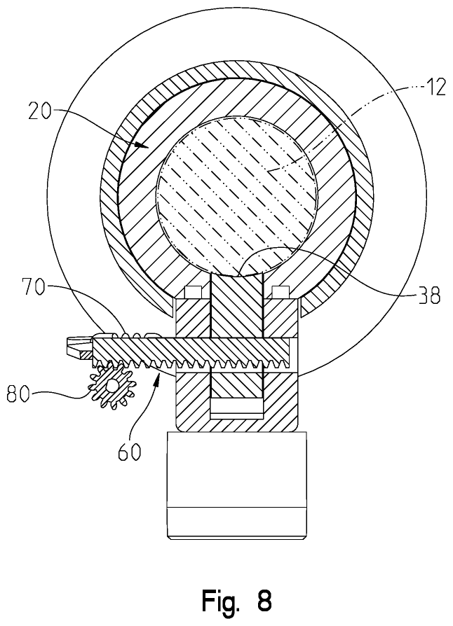

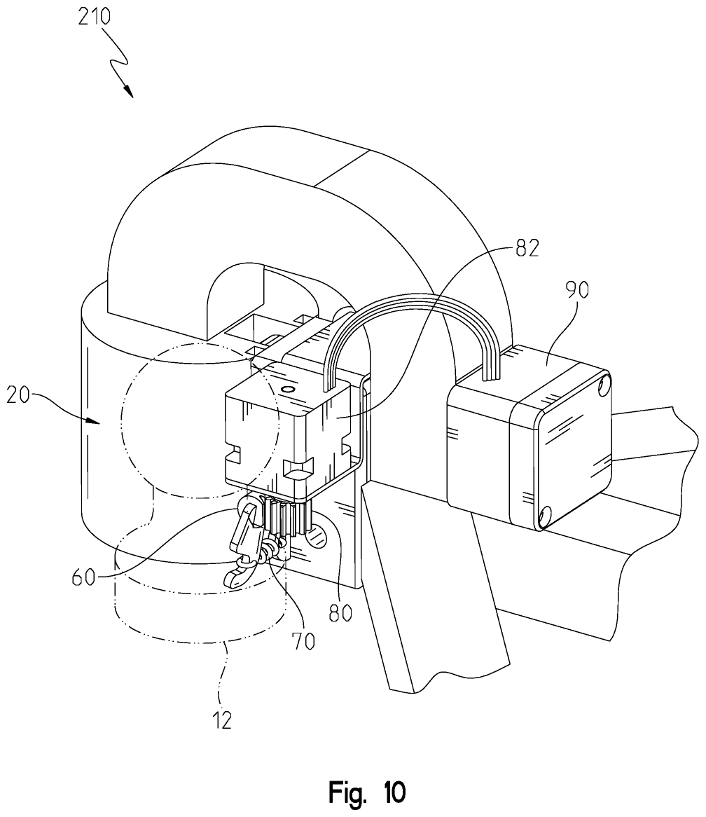

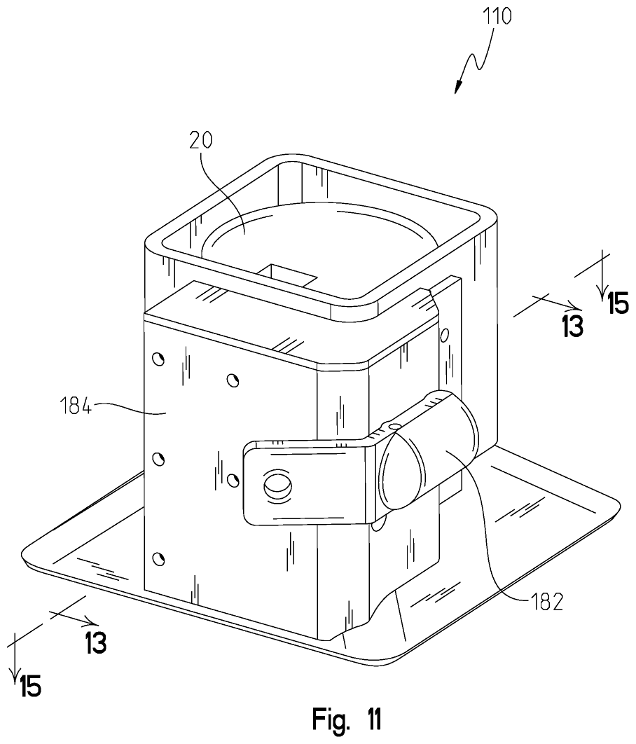

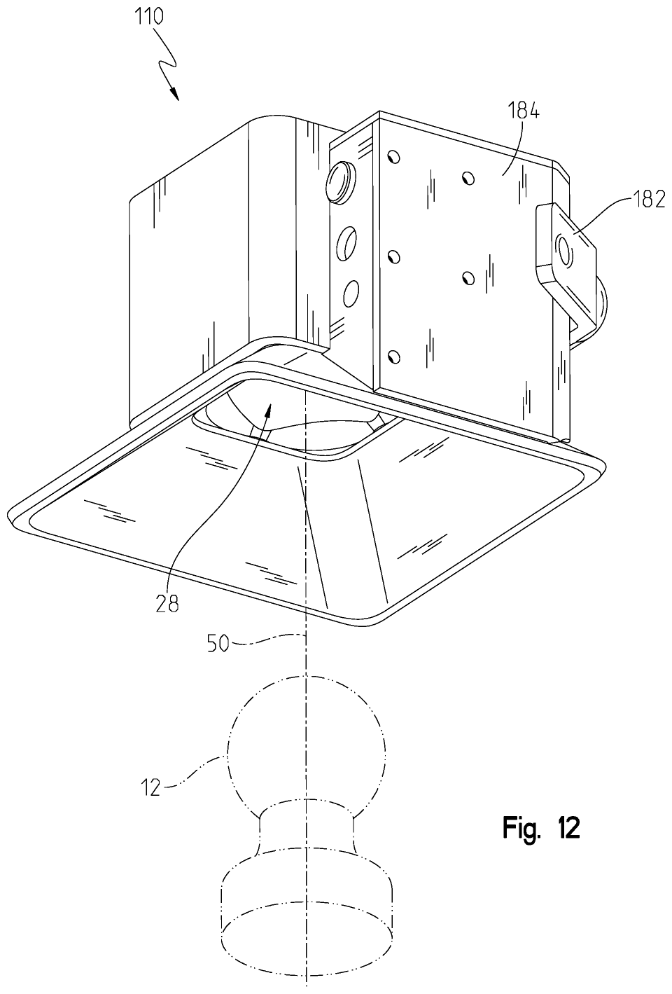

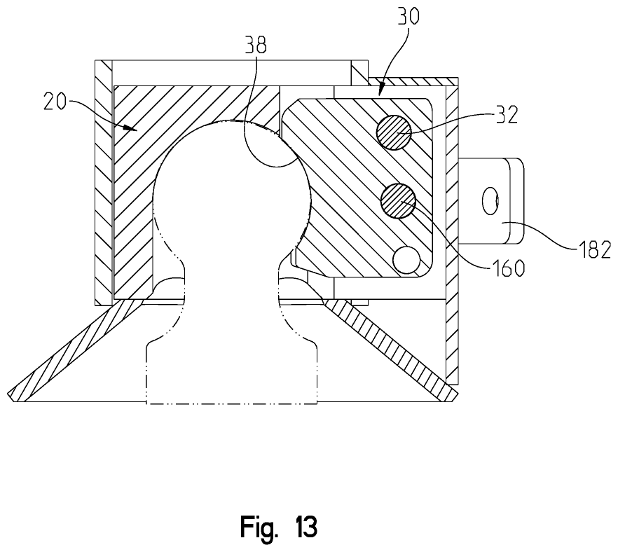

The coupler 10 shown in FIGS. 1-8 is useable with a gooseneck trailer, with a manual coupler 110 shown in FIGS. 11-16, and a bumper version of the coupler 210 shown in FIGS. 9-10 being useable with a bumper-mounted or rear-mounted hitch ball. For the purposes of simplicity, the gooseneck version of the coupler 10 will be described in detail. The bumper version of the coupler 210 will then be described to the extent that it differs from the coupler 10. In the disclosures herein, the couplers 10, 110, 210 use the same operative parts, with some structural differences being related to how the locking pin is released and/or how the coupler mounts to the trailer (not shown). The coupler 10, 110, 210 is mounted to a trailer with a coupling axis 50 perpendicular or substantially perpendicular to the ground. Because vehicles and/or trailers can be located on unlevel ground, substantially perpendicular is defined as the ball pocket being sufficiently vertical for the coupler to mate with the hitch ball 12.

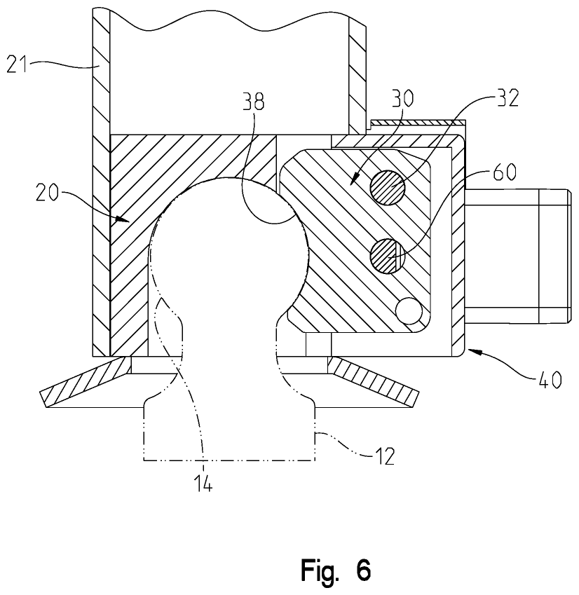

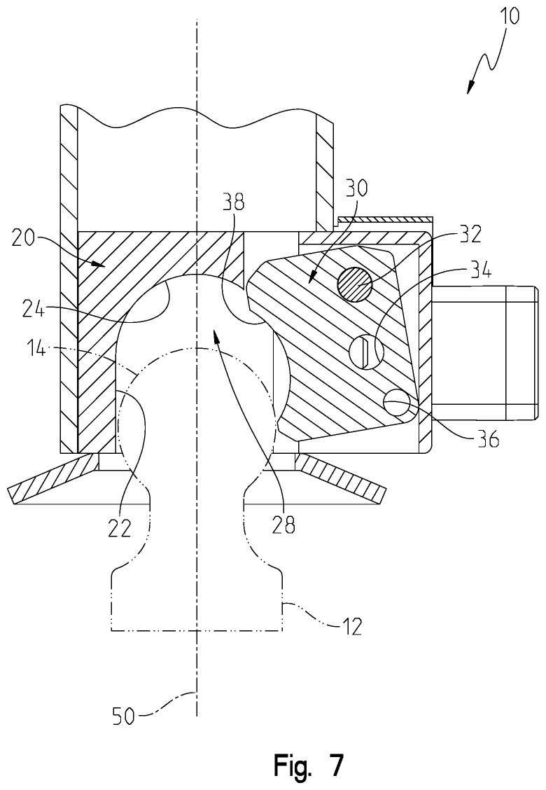

The coupler 10 has a fixed ball pocket 20 with a cylindrical inside surface 22 extending to a hemispherical surface 24. The cylindrical inside surface 22 and hemispherical surface 24 cooperate to form a partial capsule-shaped inside envelope 28. In other words, the surfaces 22, 24 combine to form one end of a spherocylindrically shaped cavity. Other names for this shape include a hemisphere cylinder. The fixed ball pocket 20 has a notch 26 that interrupts the cylindrical inside surface 22 and extends into the hemispherical surface 24. A lever 30 is retained in the notch 26 that is used to capture the hitch ball 12. The lever 30 pivots between a captured position (shown in FIG. 6) and a released position (shown in FIG. 7) about a pin 32 that is secured to a housing 40. The pin 32 is shown as being held in with a clip 33, but other methods of securing the pin 32 are contemplated. The housing 40 is fixed with respect to the fixed ball pocket 20, typically through welding. For coupler 10, the fixed ball pocket 20 and housing 40 are secured to a gooseneck tube 21 that is made to be secured to a trailer 18, as shown in FIG. 1. The fixed ball pocket 20 has grooves 23 that may be used to align with features on the housing 40, which can ensure alignment and proper positioning of the lever 30 with respect to the fixed ball pocket 20. The lever 30 is biased towards the released position through gravity, because the aperture for the pin 32 is offset from the center of gravity of the lever. It is contemplated that the lever 30 is biased with a spring or other component. The lever 30 has a locking aperture 34 that aligns with rack apertures 42 in the housing 40 when the lever is in the captured position. In the captured position, the lever 30 also has a manual locking aperture 36 that aligns with manual lock apertures 44 in the housing 40. The manual lock apertures 44 allow for a keyed or other security lock 48 to be installed. The lever 30 has a ball engagement surface 38 that is complementary to the partially spherical surface 14 of the hitch ball 12. The lever 30, and in particular, the ball engagement surface 38 portion extends into the inside envelope 28 irrespective of the lever's position. An upper portion of the engagement surface 38 extends inwardly when the lever 30 is in the release position and a lower portion of the engagement surface extends inwardly in the captured position. This is shown in FIGS. 6 and 7. At points between these two extremes, one portion or both portions extend into the inside envelope 28.

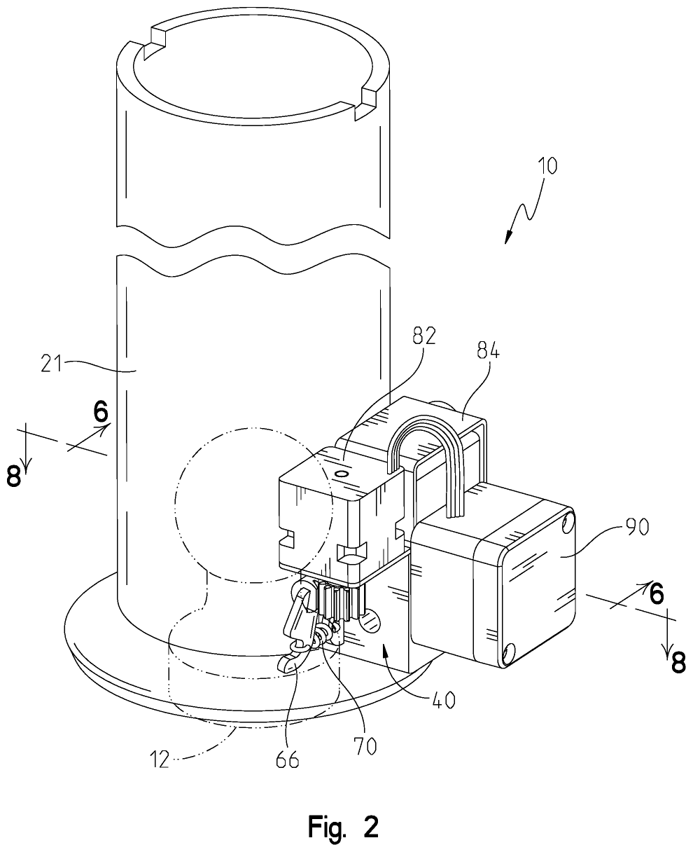

As previously disclosed, the lever 30 and housing 40 have apertures that align when the lever is in the captured position. The housing 40 includes a slidable locking pin 60 that moves along a locking axis 62 between a locked and unlocked position. The slidable locking pin 60 has a rack gear 64 and a spring hook 66. The spring hook 66 is attached to a spring 70 that is connected to the housing 40 at a spring eyelet 46. The spring 70 biases the locking pin 60 towards the locked position, which is shown in FIG. 2.

The rack gear 64 mates with a spur gear 80 that is affixed to an actuator or motor 82. The motor 82 can rotate the spur gear 80 to move the locking pin 60 along the locking axis 62. The motor 82 is mounted to a bracket 84 and is electrically connected to a control 90. While the motor 82 and control 90 are shown as separate components, it is contemplated that the control and motor are integrated into a single unit or enclosure. The control 90 houses electronics that are either battery-powered, powered from the trailer, or powered by the towing vehicle. Optionally, a sensor is located in the fixed ball pocket 20 or another location to detect the presence of the hitch ball 12. The sensor can be magnetic, proximity, or any type of sensing technology that detects the presence or movement of the hitch ball, lever, or other components discussed herein. When the hitch ball 12 seats into the fixed ball pocket 20 or is removed from it, the sensor sends a signal to the control 90. It is contemplated that the sensor is located to detect the position of the lever 30. The sensor is in electrical communication with the control 90 and can be used to notify the user of the status of the hitch and/or be used to move the motor 82. The electronics control the motor 82 and can receive signals from a wireless remote, communicate over Bluetooth, NFC, or other protocol. Bluetooth, NFC, or other protocols are used with smartphones, tablets, or other mobile devices that would have a custom program/application. The application would provide the status of the motor, sensor(s), and battery level, along with providing control for the motor to release the coupler.

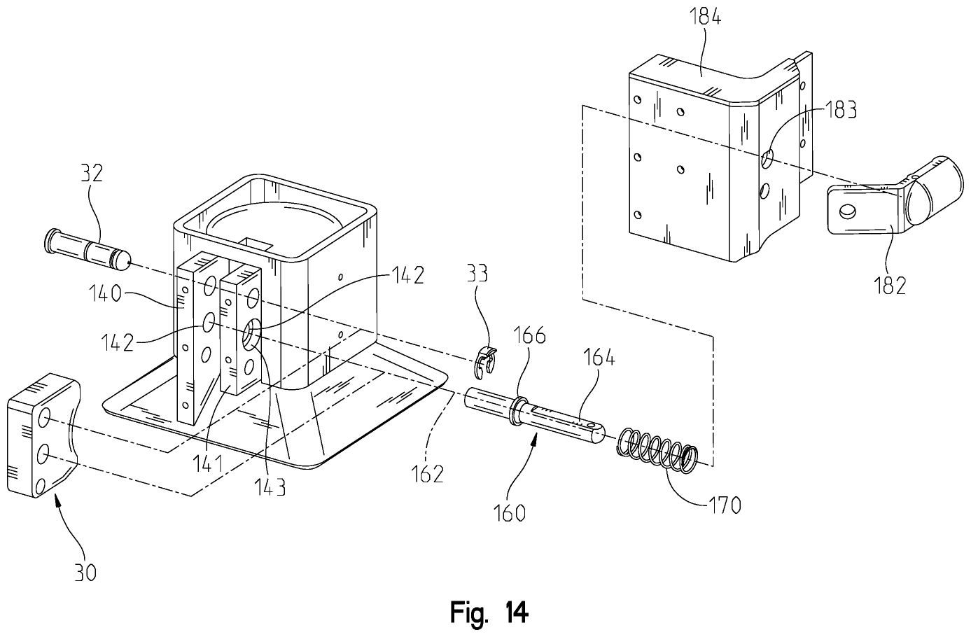

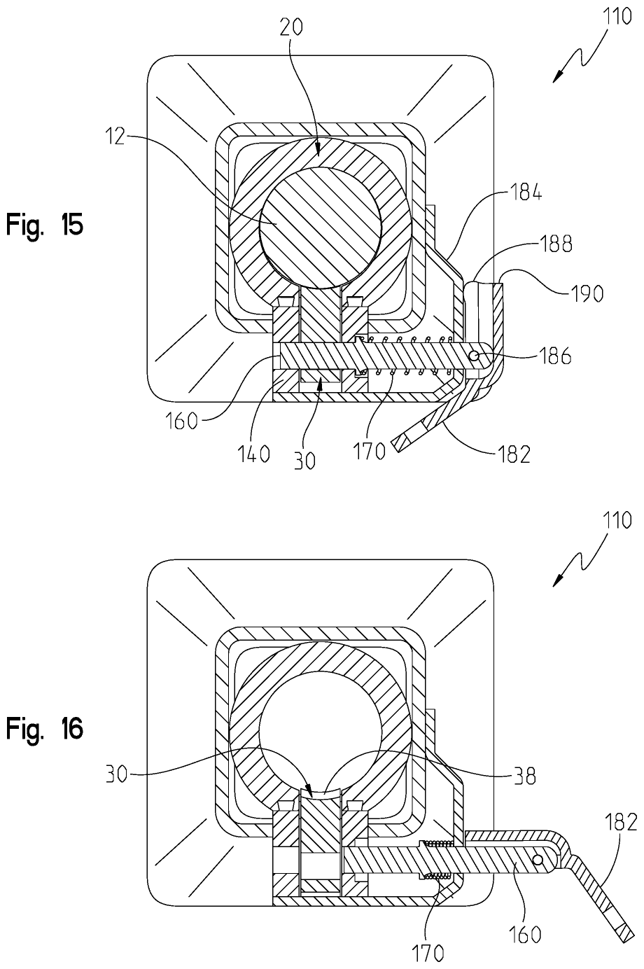

The manual version of the coupler 110 is shown in FIGS. 11-16, where the motor, controller, and optional sensor are not present. Coupler 110, like coupler 10, uses the fixed ball pocket 20 and lever 30. The differences between coupler 10 and coupler 110 are related to how the locking pin 160 is moved to the unlocked position. A first housing side 140 and a second housing side 141 cooperate with a guide bracket 184 to form a housing. The first and second housing sides 140, 141 have apertures 142 for the locking pin 160. The locking pin 160 slides along a locking axis 162, shown in FIG. 14. As shown in FIGS. 15-16, the locking pin 160 is attached to a release lever 182 and biased towards the locked position by a spring 170. The spring 170 is held between a guide bracket 184 and a step 166 located on the locking pin. The step 166 could be integrated into the locking pin 160 or be a clip (such as a c-clip or e-clip) attached thereto. The second housing side 141 has a pocket 143 to receive the step 166 in the locked position. The locking pin 160 has a guide flat 164 that cooperates with an aperture 183 in the guide bracket 184 to prevent the locking pin 160 from rotating and maintain alignment and orientation of the pin and release lever. The release lever 182 is tied to the locking pin 160 by a lever pivot 186 which allows the release lever 182 to pivot with respect to the locking pin 160. The release lever 182 has a rounded surface 188 that slides along the guide bracket 184 and an end surface 190 that can hold the locking pin 160 in the unlocked position.

The bumper version of the coupler 210 is shown in FIGS. 9-10 and may either be manual, like coupler 110 or electrically-actuated like coupler 10.

As previously described, the coupler 10, 110, 210 releases and captures the hitch ball 12 through the movement of the lever 30. When the hitch ball 12 absent from the inside envelope 28 and the locking pin 60, 160 is in the unlocked position, the lever 30 is free to move between the release and capture positions but will naturally rotate to the release position through gravity. This puts the coupler 10, 110, 210 into a condition to receive the hitch ball 12. The upper portion of the engagement surface 38 extends into the inside envelope 28 in this position. At the same time, the locking pin 60, 160 is biased towards the locked position but cannot reach it because the locking aperture 34 is not aligned. Instead, the locking pin is biased against the side of the lever 30. When the hitch ball 12 is moved into the inside envelope 28, it meets the upper portion of the engagement surface 38, where it begins to rotate the lever 30 towards the captured position. As the hitch ball 12 reaches a fully seated position against the hemispherical surface 24, the lever 30 reaches the captured position, which aligns the locking aperture 34 with the locking pin 60, 160. The bias pressure on the locking pin (from the spring 70, 170) causes it to extend through the locking aperture 34 completely and through apertures 42, 142. The hitch ball 12 is held in place by the lower portion of the engagement surface 38 while the lever 30 is locked from rotating by the locking pin. To release the hitch ball 12, the user pulls the locking pin 60, 160 out of the locking aperture 34. For the manual versions, this is done by actuating the handle 182, while in the electrically-actuated version it is moved by the motor 82. Removing the locking pin from the locking aperture allows the lever 30 to swing to the released position, thereby allowing the hitch ball 12 to withdraw.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A coupler for retaining a hitch ball affixed to a towing vehicle, said coupler comprising:
a fixed ball pocket having a cylindrical inside surface extending to a hemispherical inside surface, said cylindrical and hemispherical inside surfaces cooperating to form an inside envelope, said fixed ball pocket having a notch interrupting a portion of said hemispherical and cylindrical surfaces;
a lever located in said notch and pivotable between a captured position and a release position, a portion of said lever extending into said inside envelope, said lever having a locking aperture;
when said lever is in said release position, said portion of said lever extending into said inside envelope is adjacent said hemispherical surface, when said lever is in said captured position, said portion of said lever extending into said inside envelope is adjacent said cylindrical surface; and
a locking pin is slidable along a locking axis between a locked and unlocked position, said locked position defined as said locking pin extending through said locking aperture in said lever, said unlocked position defined as said locking pin being clear of said lever, said locking pin is biased towards said locked position and is slidable through said locking aperture to said locked position when said lever is in said captured position.

2. The coupler of claim 1, further comprising an electrical actuator coupled to said locking pin to move said locking pin along said locking axis, said locking pin includes a rack gear, said electrical actuator is mated to said rack gear.

3. The coupler of claim 2, wherein said actuator is in electrical communication with a control, said control for communicating with a wireless device.

4. The coupler of claim 3, further comprising a sensor to detect said hitch ball seated in said inside envelope, said sensor is in electrical communication with said control.

5. The coupler of claim 1, further comprising a release lever pivotably coupled to said locking pin to move said locking pin along said locking axis, said locking pin having a step, a spring located between said housing and said step.

6. The coupler of claim 1, wherein said locking pin is connected to a release lever.

7. The coupler of claim 6, wherein said locking pin has a guide flat and said guide bracket has an aperture complementary to said guide flat to prevent said locking pin from rotating.

8. A coupler for retaining a hitch ball affixed to a towing vehicle, said coupler comprising:
a fixed ball pocket having a cylindrical inside surface extending to a hemispherical inside surface, said cylindrical and hemispherical inside surfaces cooperating to form an inside envelope, said fixed ball pocket having a notch interrupting a portion of said hemispherical and cylindrical surfaces;
a lever located in said notch and pivotable between a captured position and a release position, a portion of said lever extending into said inside envelope, said lever having a locking aperture;
when said lever is in said release position, said portion of said lever extending into said inside envelope is adjacent said hemispherical surface, when said lever is in said captured position, said portion of said lever extending into said inside envelope is adjacent said cylindrical surface;
a locking pin is slidable along a locking axis between a locked and unlocked position, said locked position defined as said locking pin extending through said locking aperture in said lever, said unlocked position defined as said locking pin being clear of said lever, said locking pin is biased towards said locked position and is slidable through said locking aperture to said locked position when said lever is in said captured position; and
an electrical actuator coupled to said locking pin to move said locking pin along said locking axis, said locking pin includes a rack gear, said electrical actuator is mated to said rack gear.

9. The coupler of claim 8, wherein said actuator is in electrical communication with a control, said control for communicating with a wireless device.

10. The coupler of claim 9, further comprising a sensor to detect said hitch ball seated in said inside envelope, said sensor is in electrical communication with said control.

11. A coupler for retaining a hitch ball affixed to a towing vehicle, said coupler comprising:
a fixed ball pocket having a cylindrical inside surface extending to a hemispherical inside surface, said cylindrical and hemispherical inside surfaces cooperating to form an inside envelope, said fixed ball pocket having a notch interrupting a portion of said hemispherical and cylindrical surfaces;
a lever located in said notch and pivotable between a captured position and a release position, a portion of said lever extending into said inside envelope, said lever having a locking aperture;
when said lever is in said release position, said portion of said lever extending into said inside envelope is adjacent said hemispherical surface, when said lever is in said captured position, said portion of said lever extending into said inside envelope is adjacent said cylindrical surface;
a locking pin is slidable along a locking axis between a locked and unlocked position, said locked position defined as said locking pin extending through said locking aperture in said lever, said unlocked position defined as said locking pin being clear of said lever, said locking pin is biased towards said locked position and is slidable through said locking aperture to said locked position when said lever is in said captured position; and
a release lever pivotably coupled to said locking pin to move said locking pin along said locking axis, said locking pin having a step, a spring located between said housing and said step.

12. The coupler of claim 11, wherein said locking pin is connected to said release lever.

13. The coupler of claim 12, wherein said release lever has an end surface to hold said locking pin in said unlocked position.

14. The coupler of claim 12, wherein said locking pin has a guide flat and a guide bracket has an aperture complementary to said guide flat to prevent said locking pin from rotating.
